(19) United States
(12) Patent Application Publication
(10) Pub. No.: US 2026/0307949 A1
(43) Pub. Date: Oct. 8, 2026

(54) LIGHT WEIGHT LOAD BEARING HOIST RING WITH ROUND SLING BAIL

(71) Applicant: Chant Engineering Co. Inc., New Britain, PA (US)

(72) Inventors: Philip Chant, Perkasie, PA (US); Mason Chant, Perkasie, PA (US); Stephen Grzeczkowski, Chalfont, PA (US)

(21) Appl. No.: 19/642,218

(22) Filed: Apr. 8, 2026

Related U.S. Application Data
(60) Provisional application No. 63/785,409, filed on Apr. 8, 2025.

(51) Int. Cl. B66C 1/66; B66C 1/12

(52) U.S. Cl. CPC B66C 1/66; B66C 1/12

(57) ABSTRACT

A light weight load bearing hoist ring that includes a round sling bail and a load connection device. The round sling bail is made of a plurality of loops of fiber rope secured within a sheathing. Opposing sides of the bail are secured together in middle while loops are formed at ends. The load connection device is configured to secure to a load via bolts or welding. The loops of the bail may be secured to high strength thimbles (e.g., steel) in such a fashion to remain secured together under an in line or angled load. The thimbles may be used to connect the bail to the load connection device. Alternately, the loops may be directly connected to the load connection device. The bail is capable of pivoting with respect to the load connection device and swiveling with respect to the load without disconnecting from the load.

### BACKGROUND

Eye bolts are used for providing a lifting point for a objects. However, eye bolts are limited in use by the fact that they can only be used for inline (straight) lifting. Hoist rings serve as a versatile lifting point that provides multidirectional articulation, making them ideal for complex lifting tasks. Hoist rings typically include a “U” shaped bail with a load connection device located between the legs of an open end of the bail. The load connection device may include a body, a washer, a bolt and a bushing. The body may be secured to the bail with connection pins. The bolt runs through a center of the body and is used to connect to the load to be lifted. The washer is to secure the bolt within the body. The bushing is designed to enable the body to be rotated around the load to be lifted without removing the bolt from the object. The load connection device is designed to rotate when not under load and the bail is designed to pivot around the load connection device.

Hoist rings vary in size, shape, orientation and configuration depending on what they are used for. Hoist rings may be used in lifting operations to connect an object to a lifting apparatus, such as a crane (often referred to as load bearing hoist rings). The manner in which the hoist rings are utilized to connect the object to the lifting apparatus may vary depending on numerous factors including, but not limited to, type of lifting apparatus used, and size and weight of object to be lifted. Load bearing hoist rings are typically made with a heavy duty, strong and durable material, such as steel.

The weight associated with load bearing hoist rings may make them hard to handle, and in certain circumstances may require a lifting apparatus to put in place. Furthermore, the weight factors into the maximum load calculations. Moreover, the rigid form of the load bearing hoist rings make them tough to utilize in certain situations, for example, where space is limited.

What is needed is a light weight load bearing hoist ring that is strong, durable and safe to use. Moreover, a load bearing hoist ring that is flexible so that it can be utilized in various situations, including where space is limited is desired. Furthermore, a corrosion resistant load bearing shackle is preferable.

### BRIEF DESCRIPTION OF THE DRAWINGS

The features and advantages of the various embodiments will become apparent from the following detailed description in which:

FIG. 1A-E illustrate perspective, front, top, side and cross-sectional views of an example round sling bail, according to one embodiment;

FIG. 2 illustrates an exploded view of an example light weight load bearing hoist ring, according to one embodiment;

FIGS. 3A-E illustrate perspective, top, bottom, side and front views of example thimbles included in example round sling bails that may be used in example hoist rings, according to one embodiment;

FIGS. 3F-H illustrate perspective, front and side views of an example alterative thimbles included in example round sling bails that may be used in example hoist rings, according to one embodiment;

FIGS. 4A-E illustrate perspective, front, side, top and bottom views of the example light weight load bearing hoist ring of FIG. 2, according to one embodiment;

FIG. 4F illustrates a front cross-sectional view of the example hoist ring of FIG. 2 being secured to a load, according to one embodiment;

FIG. 4G illustrates a side view showing pivoting of the example hoist ring of FIG. 2, according to one embodiment;

FIG. 4H illustrates a top view showing the swiveling of the example hoist ring of FIG. 2, according to one embodiment;

FIG. 5 illustrates an exploded view of an example light weight load bearing hoist ring, according to one embodiment;

FIG. 6 illustrates an exploded view of an example light weight load bearing hoist ring, according to one embodiment;

FIGS. 7A-D illustrate top, front, bottom and side views of an example upper portion of an example body of an example load connection device that may be used in example hoist rings, according to one embodiment;

FIGS. 8A-C illustrate top, side and bottom views of an example base of an example body of an example load connection device that may be used in example hoist rings, according to one embodiment;

FIGS. 9A-E illustrate perspective, top, bottom, side and front views of example thimbles included in example round sling bails that may be used in example hoist rings, according to one embodiment;

FIGS. 10A-E illustrate perspective, front, side, top and bottom views of the example light weight load bearing hoist ring of FIG. 6, according to one embodiment;

FIG. 10F illustrates a front cross-sectional view of the example hoist ring of FIG. 6 being secured to a load, according to one embodiment;

FIG. 11 illustrates an exploded view of an example light weight load bearing hoist ring, according to one embodiment;

FIGS. 12A-B illustrate front and top views of an example weldable base of an example body of an example load connection device used in example hoist rings, according to one embodiment;

FIGS. 13A-C illustrate perspective, side and front views of the example light weight load bearing hoist ring of FIG. 11, according to one embodiment;

FIG. 13D illustrates a front cross-sectional view of the example hoist ring of FIG. 11 being secured to a load, according to one embodiment;

FIGS. 14A-14F illustrate exploded, perspective, front, side, top and bottom views of an example light weight fiber rope hoist ring, according to one embodiment;

FIG. 14G illustrates a front cross-sectional view of the example hoist ring of FIGS. 14A-F being secured to a load, according to one embodiment;

FIG. 15 illustrates an exploded view of an example light weight fiber rope hoist ring where the example round sling bail does not include thimbles, according to one embodiment;

FIGS. 16A-D illustrate perspective, side, top and front cross-sectional views of a configuration of an example bail that may be used in example hoist rings, according to one embodiment;

FIGS. 16E-F illustrate perspective views of loops of an example bail wrapped around a rod and bushing sleeve of an example load connection device that may be used in example hoist rings, according to one embodiment;

FIGS. 17A-D illustrate perspective, front, top and side views of an example housing of an example load connection device that may be used in example hoist rings, according to one embodiment; and

FIGS. 18A-G illustrate perspective, top, bottom, front, front cross-sectional, side and side cross-sectional views of the example hoist of FIG. 15, according to one embodiment.

### DETAILED DESCRIPTION

A light weight load bearing hoist ring that is corrosion resistant and still provides the strength and durability required to lift loads is provided. The hoist ring includes a bail and a load connection device. The load connection device is to connect to a load and the bail enables pivoting with respect to the load connection device when secured to the load. To reduce the weight of the hoist ring the bail is made of a fiber rope (e.g., synthetic fiber). The fiber rope may be made of, for example, polypropylene, nylon, polyesters (e.g., PET, LCP, Vectran), polyethylene (e.g., Dyneema and Spectra), Aramids (e.g., Twaron, Technora and Kevlar) and acrylics (e.g., Dralon). Some fiber ropes may be constructed of mixtures of several fibers or use co-polymer fibers. The fibers making up the rope may be straight, braided and/or twisted. The number, orientation and configuration of the fibers may vary depending on the type of light weight load bearing hoist ring it is too be used in. The fibers and/or the fiber rope may be coated. The fiber rope is wound into a plurality of loops and the plurality of loops are located within a sheathing. The sheathing may be made of, for example, polypropylene, nylon, polyesters (e.g., PET, LCP, Vectran), polyethylene (e.g., Dyneema, Spectra), Aramids (e.g., Twaron, Technora, Kevlar) and acrylics (e.g., Dralon). A plurality of loops of fiber rope wrapped within a sheathing is often referred to as round sling.

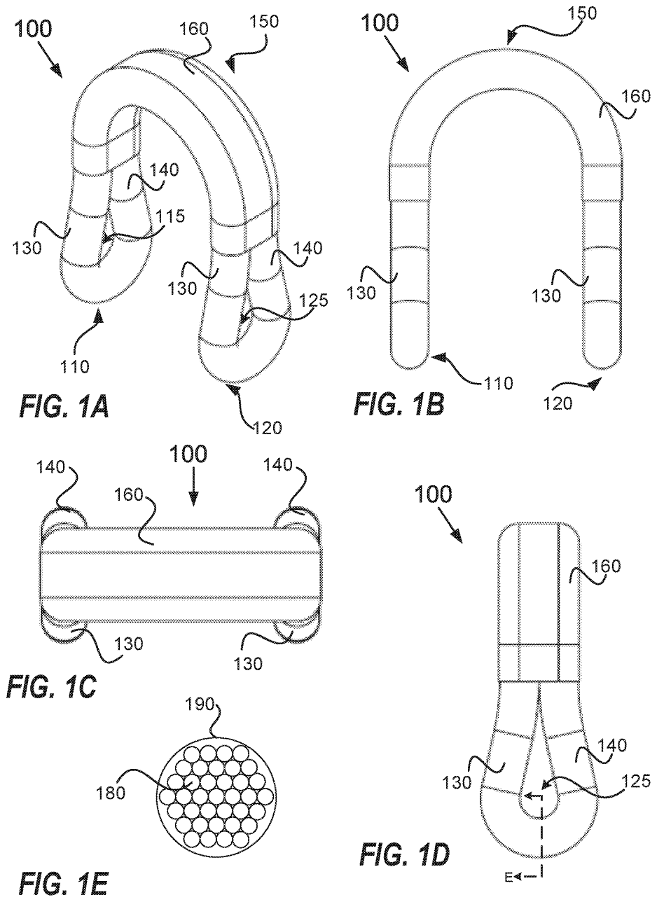

FIG. 1A-E illustrate perspective, front, top, side and cross-sectional views of an example round sling bail 100. As noted above, the bail 100 is formed from a plurality of loops of fiber rope 180 withing a sheathing 190. The fiber rope 180 is not visible in FIGS. 1A-D as it is located internal to the sheathing 190 and the sheathing 190 is not separately identified. The sheathing 190 may have a narrow width profile so that when the loops of fiber rope 180 are located therewithin, the filled sheathing 190 has a round profile. FIG. 1E illustrates a cross-sectional view of the example bail 100 where the sheathing 190 has a substantially round profile when filled with a plurality of loops of fiber rope 180.

The bail 100 is illustrated configured in a U-shape where each leg 110, 120 of the bail 100 has an opening 115, 125. The U-shape is the standard shape of the bail of a steel hoist ring and is the likely shape the bail 100 will be when the light weight load bearing hoist ring is configured for use, or is in use. When the light weight load bearing hoist ring is not configured for use, or in use, the bail 100 could be flexed, folded and/or twisted into a desired configuration. A first side 130 and a second side 140 of the sheathing 190 (round sling) are placed next to each other and are secured together at a central portion thereof 150. The first and the second sides 130, 140 may be secured together by placing the first and the second sides 130, 140 within a second sheathing 160. The second sheathing 160 may be made of, for example, polypropylene, nylon, polyesters (e.g., PET, LCP, Vectran), polyethylene (e.g., Dyneema, Spectra), Aramids (e.g., Twaron, Technora, Kevlar) and acrylics (e.g., Dralon). The first and second sides 130, 140 are not secured together at ends of the first and second legs 110, 120 of the sheathing 190, so the first and second openings 115, 125 are formed. The sheathing 190 is formed into the U-shape.

The bail 100 is secured to the load connection device to enable pivoting of the bail 100 with respect to the load connection device. There are various styles of load connection devices that are utilized with standard hoist rings and similar configurations can be used with lightweight fiber rope hoist rings. The load connection devices may include a body, a bolt for securing to a load, a washer to hold the bolt within the body and a bushing to allow for compression so that the bail and body can rotate without having the bolt removed from the load. There are various manners of securing the bail 100 to the load connection device. The bail 100 should be secured to the load connection device in a manner that they will stay engaged when under a load, whether the load is in line or an angle. According to one embodiment, the body of the load connection device may be secured to the bail 100 with pins. This would require that the bail 100 include some type of thimble within the openings 115, 125 to secure the pin to the bail 100.

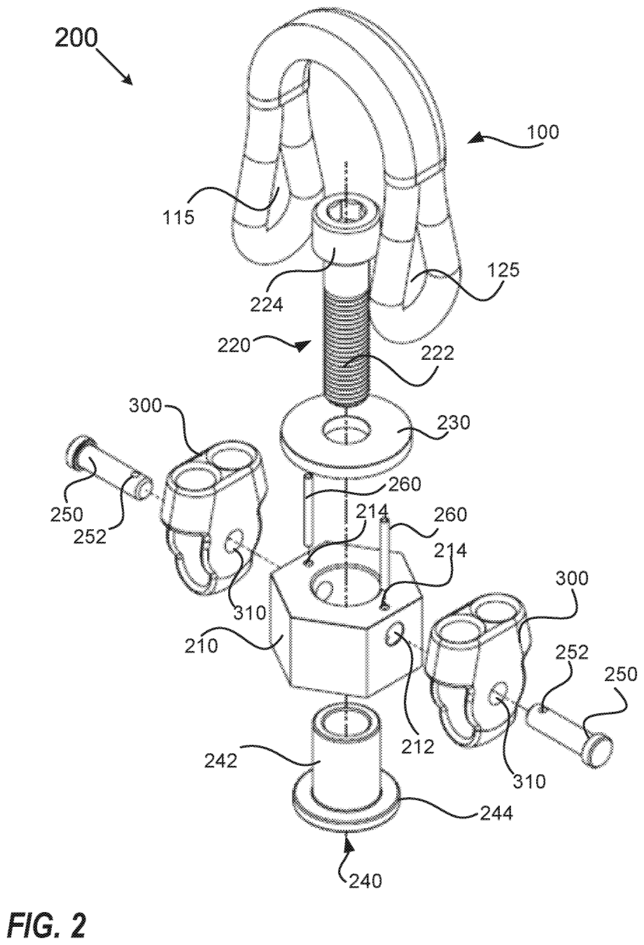

FIG. 2 illustrates an exploded view of an example light weight load bearing hoist ring 200. The hoist ring 200 includes a round sling bail (e.g., the example bail 100) and a load connection device. The legs of the bail 100 are routed through thimbles 300 so that the thimbles 300 are located within the openings 115, 125 of the bail 100. The thimbles 300 need to be secured in a manner that they will stay engaged with the bail 100 when the hoist ring 200 is under a load, whether the load is in line or an angle. The thimbles 300 includes holes 310 therein. The load connection device includes a body 210, a bolt 220, a washer 230, and a bushing 240. The body 210 includes holes 212 formed on sides thereof in alignment with the holes 310. The body 210 is secured to each thimble 300 with connections pins 250. The connection pins 250 have a body and a head where the body passes through the aligned holes 310, 212. The connections pins 250 may include holes 252 formed therein and the body 210 may include holes 214 on top thereof in alignment with the holes 252 when the pins 250 are inserted. Additional pins 260 may be utilized to secure the connection pins 250 in the body 210 by passing through the aligned holes 214, 252. The manner in which the connection pins 250 are secured in the body 210 is not limited to the illustrated embodiments. The thimbles 300 are configured and connected in such as fashion (e.g., connections pins 250 not threadedly secured to thimbles 300) to pivot with respect to the body 210 in order to enable the bail 100 to pivot with respect to the load connection device.

The washer 230 is located on top of the body 210, a sleeve 242 of the bushing 240 is located within the body 210 and a flange 244 of the bushing 240 is located below the body 210. A portion of the bolt 220 passes through the washer 230, the body 210 and the bushing 240 so that a threaded portion 222 (or a portion thereof) extends from the bottom thereof and can be used to secure to a load. The threaded portion 222 may be secured to a threaded hole in a load or may pass through a hole in the load and be secured thereto with, for example, a nut. The washer 230 is used to secure a head 224 of the bolt 220 above the body 210. The bushing sleeve 242 is used to enable the bolt 220 to pass through the body 210 without engaging the body 210 and the bushing flange 244 is to secure the body 210 above the load and provide an appropriate amount of compressive strength therebetween. When secured to the load, the body 210 (along with the bail 100) may swivel around the load without disconnecting the threaded portion 222 from the load as neither the bolt 220 nor the load are in direct contact therewith.

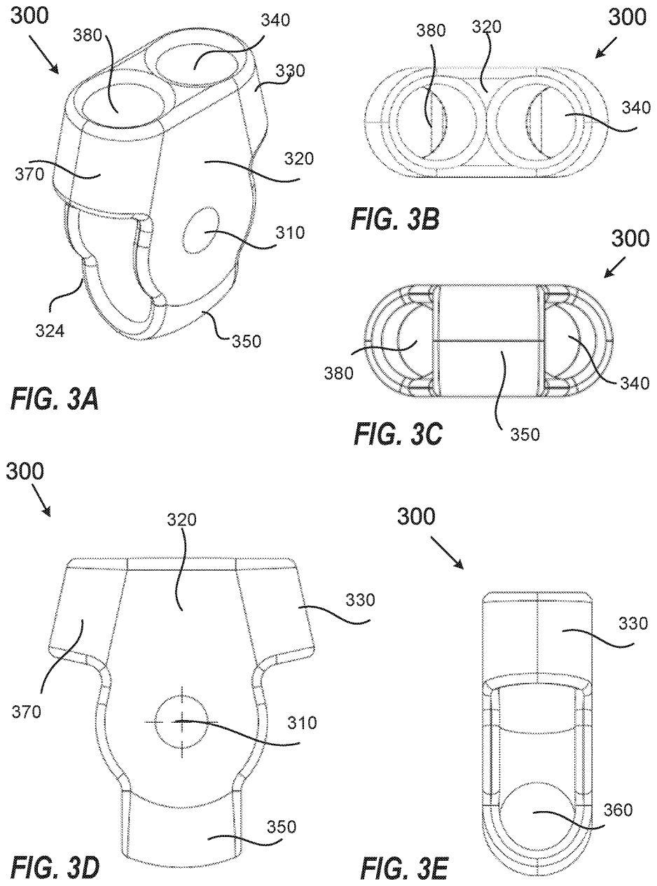

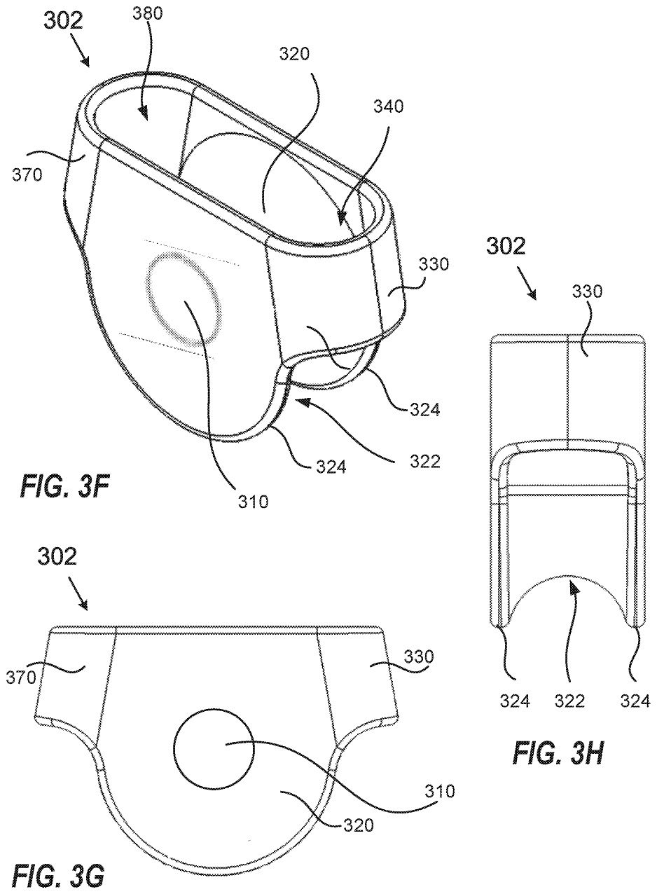

FIGS. 3A-E illustrate perspective, top, bottom, side and front views of the example thimbles 300 (the views are based on how the thimble 300 would be configured in the hoist ring 200 of FIG. 2). The thimbles 300 includes a main body 320 having the hole 310 formed therethrough. An exterior of the main body 320 has sidewalls 324 extending therefrom to create a groove/open channel 322 (not really visible and not identified) therearound for receiving the bail 100 therein. Several flanges (3 illustrated) 330, 350, 370 are located along an exterior to enclose the groove and create closed channels 340, 360, 380 for securing the bail 100 to the thimble 300. The flanges 330, 370 are illustrated on opposite sides of a top of the thimble 300 and the flange 350 is located along a bottom thereof. The use of the groove 322 and the flanges (e.g., 330, 350, 370) to create the closed channels (e.g., 340, 360, 380) ensures that the bail 100 remains connected to the thimbles 300 when the hoist ring 200 is under a load, whether the load is in line or an angle.

The number and location of flanges is not limited to the illustrated embodiment. Flanges located in proximity to the top of the thimble 300 along each side thereof (e.g., 330, 370) are desirable to secure the bail 100 to the thimble 300. Other flanges (e.g., 350) may provide additional support but may not be required and it may be difficult to route the bail 100 through the associated channel (e.g., 360).

FIGS. 3F-H illustrate perspective, front and side views of an example alterative first thimble 302. The thimble 302 is basically the same except that only the flanges 330, 370 located on opposite sides of a top of the thimble 302 are included to provide the channels 340, 380 as they sufficiently secure the bail 100 to the thimble 302 without the difficulty of having to route the bail 100 through other channels. The groove 322 formed around the main body 320 by sidewalls 324 extending from the main body 320 is more visible in the perspective and side views. The groove 322 and the closed channels 340, 380 ensures that the bail 100 remains connected to the thimbles 300 when the hoist ring 200 is under a load, whether the load is in line or an angle.

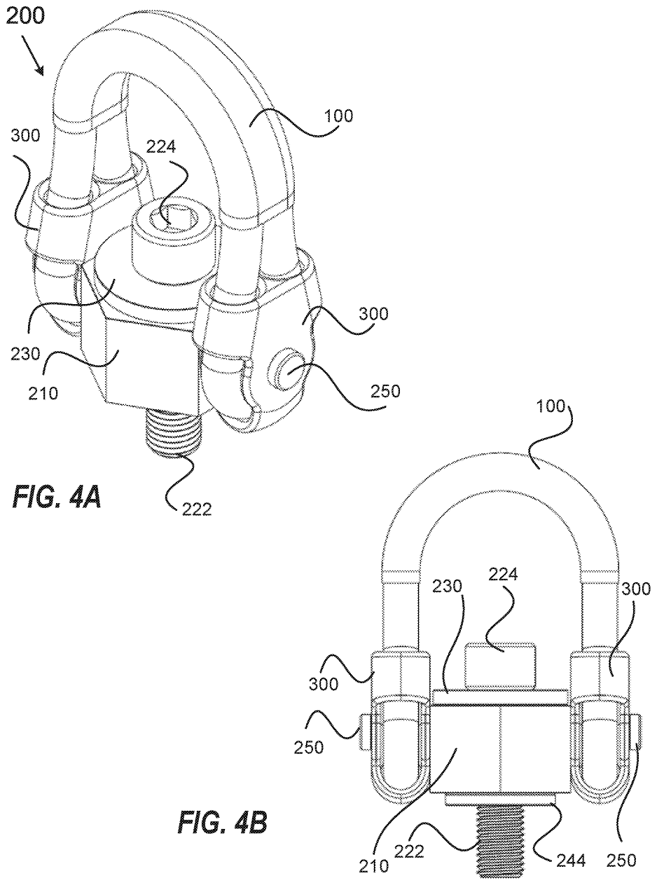

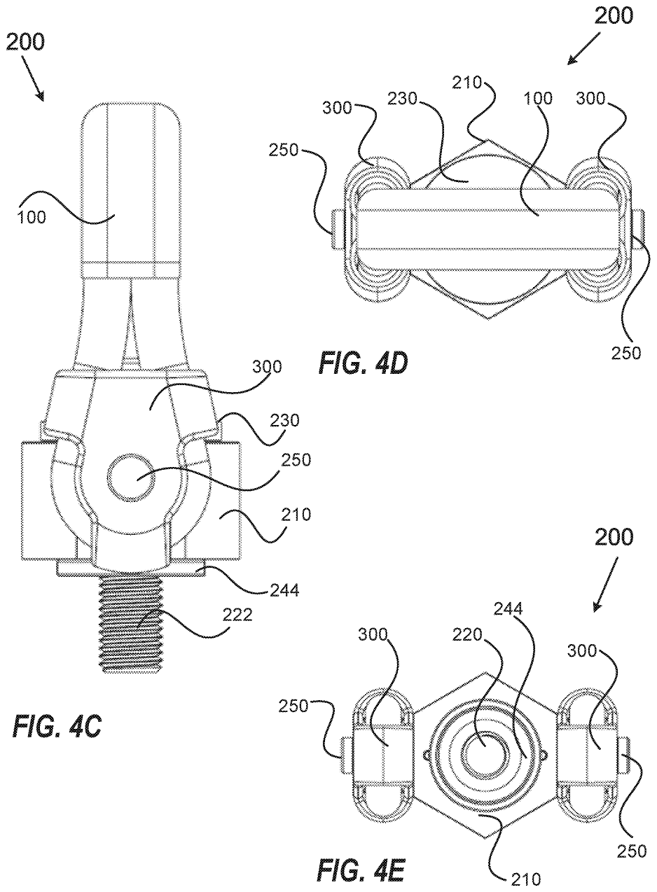

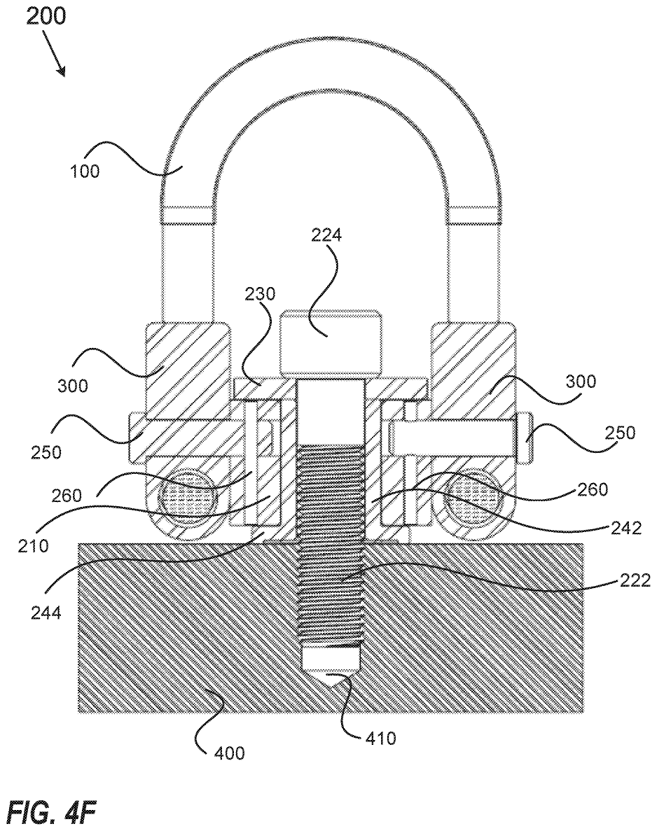

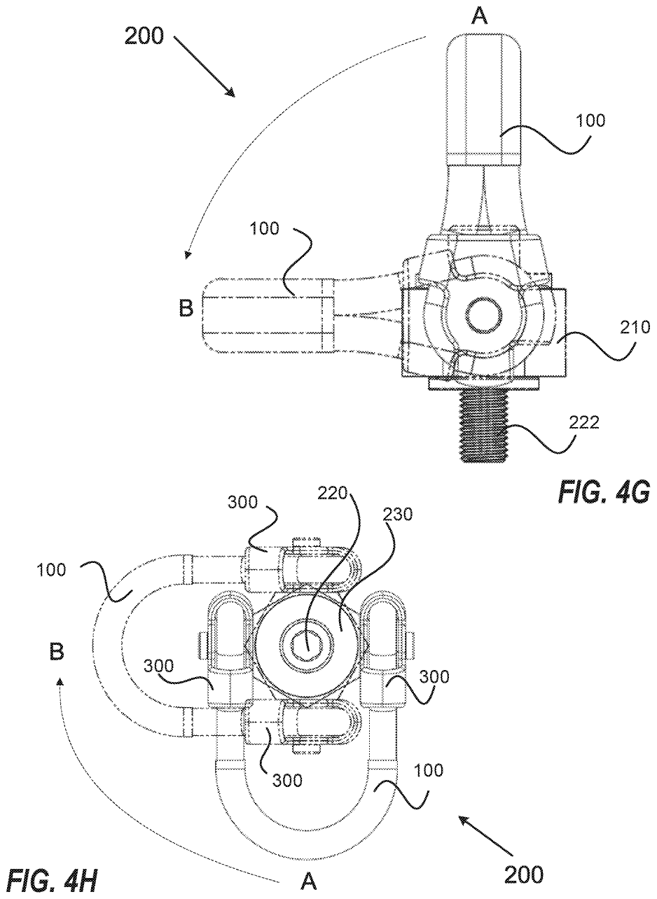

FIGS. 4A-E illustrate perspective, front, side, top and bottom views of the example light weight load bearing hoist ring 200. FIG. 4F illustrates a front cross-sectional view of the example hoist ring 200 being secured to a load 400. The threaded portion 222 is screwed into a threaded hole 410 in the load 400.

FIG. 4G illustrates a side view of the example hoist ring 200 showing how the bail 100 pivots with respect to the load connection device (body 210 identified) connected to a load (load not shown). As illustrated, the bail 100 pivots 90 degrees from position A (bail 100 extending upward from connection point) to position B (bail 100 extending to left of connection point). The bail 100 can pivot 180 degrees in total where it goes from being parallel to the load (e.g., laying on the load) in one direction (e.g., left), to being perpendicular to the load, to parallel to the load in second direction (e.g., right).

FIG. 4H illustrates a top view of the example hoist ring 200 showing how the bail 100 swivels (rotates) around location where the load connection device (bolt 220 and washer 230 identified) is connected to a load (load not shown). As illustrated, the bail 100 swivels 90 degrees from position A (thimbles 300 located on left and right of connection point, bail 100 extending downward from connection point) to position B (thimbles 300 located on top and bottom of connection point, bail 100 extending to left of connection point). The bail 100 can swivel 360 degrees around the connection point between the load and the load connection device.

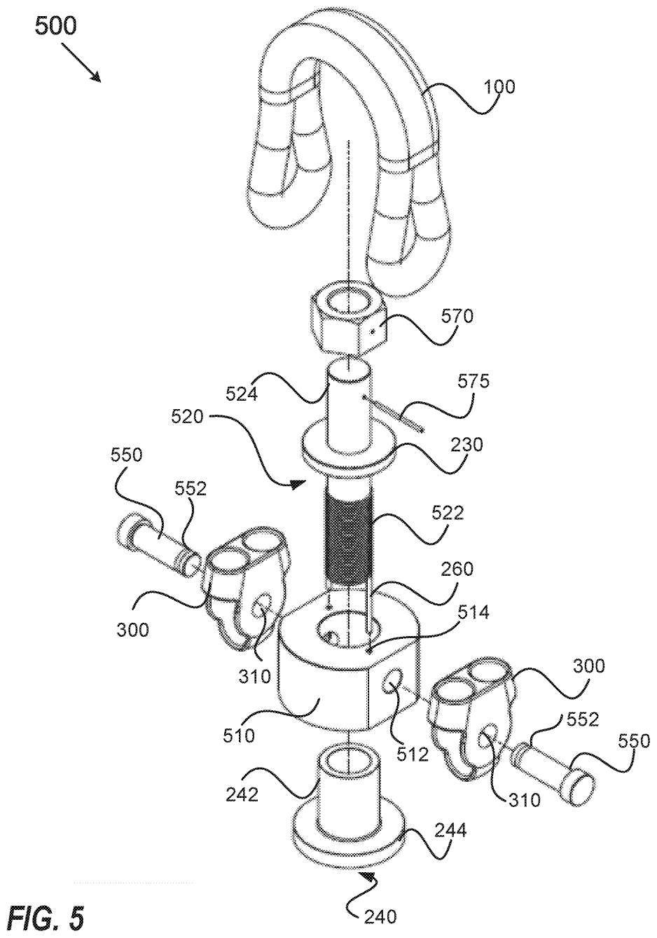

FIG. 5 illustrates an exploded view of an example light weight load bearing hoist ring 500. Items in the hoist ring 500 included in the hoist ring 200 will not be discussed in detail here as they were previously discussed. The load connection device includes a body 510, a rod 520 (having a threaded portion 522 and a non-threaded portion 524), the washer 230, and the bushing 240. The body 510 is substantially the same as the body 210 but has rounded front and back between flat sides (abutting the thimbles 300). It should be noted that the body 510 is in no way intended to be limited to the shape illustrated in FIG. 5 (or FIG. 2). The body 510 simply needs to be capable of abutting the thimbles 300.

The body 510 includes holes 512 on sides thereof in alignment with the holes 310 and is secured to each thimble 300 with connections pins 550. The connection pins 550 have a body and a head where the body passes through aligned holes 310, 512. The connections pins 550 include grooves 552 formed therein and the body 510 includes holes 514 on top thereof in alignment with the grooves 552 when the pins 550 are inserted. Additional pins 260 may be utilized to secure the connection pins 550 in the body 510 by passing through the holes 514 and the grooves 552. The manner in which the connection pins 550 are secured in the body 510 is not limited to the illustrated embodiments.

The washer 230 is located on top of the body 510, the bushing sleeve 242 is located within the body 510 and the bushing flange 244 is located below the body 510. A portion of the rod 520 passes through the washer 230, the body 510 and the bushing 240 so that the threaded portion 522 (or a portion thereof) extends from the bottom thereof and can be used to secure to a load. A non-threaded nut 570 is secured to the non-threaded portion 524 by passing a pin 570 through aligned holes (not identified) in each. It should be noted that the nut 570 and upper portion 524 could be threaded without parting from the current scope. The washer 230 is used to secure the nut 570 above the body 510.

The bail 100 of the hoist ring 500 may pivot 180 degrees with respect to the body 510. The body 510 and the bail 100 may swivel 360 degrees around the connection point between the load and the load connection device (the rod 520).

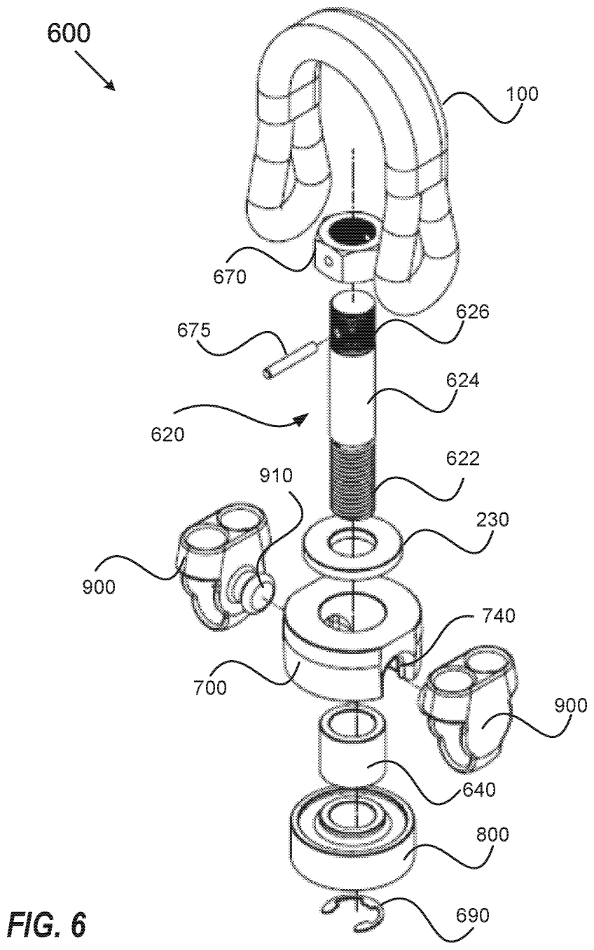

FIG. 6 illustrates an exploded view of an example light weight load bearing hoist ring 600. Items in the hoist ring 600 included in the hoist rings 200, 500 will not be discussed in detail here as they were previously discussed. The load connection device includes a body (consisting of an upper portion 700 and a base 800), a rod 620 (having a first threaded portion 622, a non-threaded portion 624, and a second threaded portion 626), the washer 230, and a bushing 640. The bushing 640 is located within the body when the upper portion 700 and the base 800 are secured together. The upper portion 700 includes channels 740 formed along each side thereof. The thimbles 900 include flanged arms 910 extending therefrom that pass through the channels 740 and are then secured in place when the base 800 is rotatably secured to the upper portion 700 (the upper portion 700 may rotate around the base 800 and the connection point when secured to a load).

The washer 230 is located on top of the upper portion 700, the bushing 640 is located within the body and the base 800 is located below the upper portion 700. The first threaded portion 622 passes through the washer 230, the upper portion 700, the bushing 640 and the base 800 and extends below the base 800 so that it can be used to secure to a load. A retaining ring 690 may be secured to the first threaded portion 622 abutting the base 800 to hold the base 800 in place on the first threaded portion 622. The non-threaded portion 624 may be located within the body and the second threaded portion 626 may extend through the upper portion 700 and the washer 230. The rod 620 may be secured in place by threading a threaded nut 670 onto the second threaded portion 626. The threaded nut 670 may be held in place by passing a pin 670 through aligned holes (not identified) in each. The washer 230 is used to secure the nut 570 above the body 510.

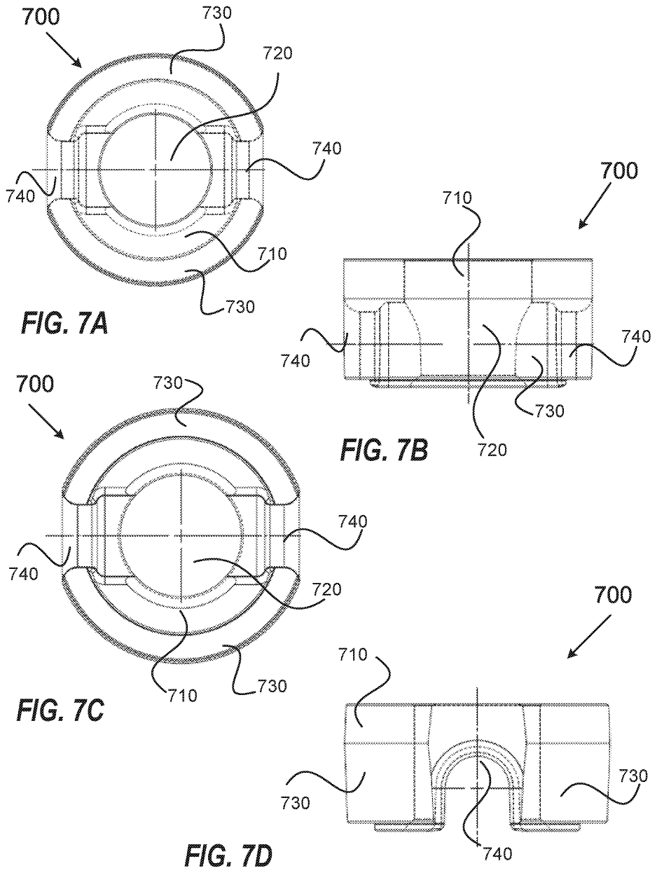

FIGS. 7A-D illustrate top, front, bottom and side views of an example upper portion 700 of an example body of an example load connection device. The upper portion 700 has a substantially circular shape but has flat sides for abutting the thimbles 900. The upper portion 700 includes an upper surface 710 having a hole 720 formed therein for allowing an example rod 620 to pass therethrough. Front and back walls 730 extend downward from the upper surface 710. The sides (flat portion) do not have sidewalls extending therefrom which creates the channels 740.

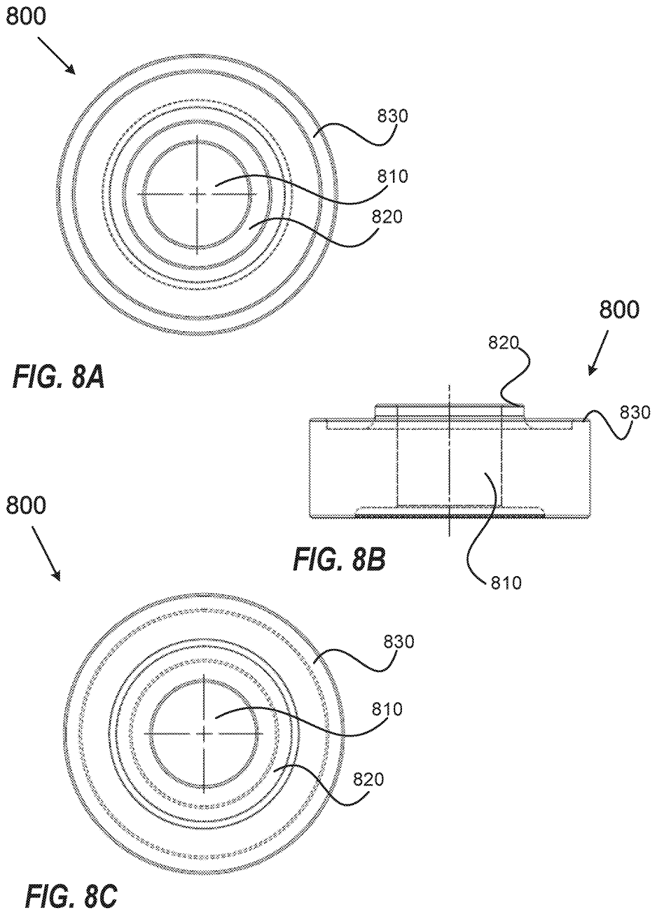

FIGS. 8A-C illustrate top, side and bottom views of an example base 800 of an example body of an example load connection device. The base 800 has a circular shape and includes a hole 810 formed therein for allowing an example rod 620 to pass therethrough. An upper surface includes an inner and outer raised portion 820, 830 for securing the bushing 640 and the upper portion 700 receptively. When the base 800 and the upper portion 700 are secured together the bushing 640 is located therebetween and the channels 740 are enclosed.

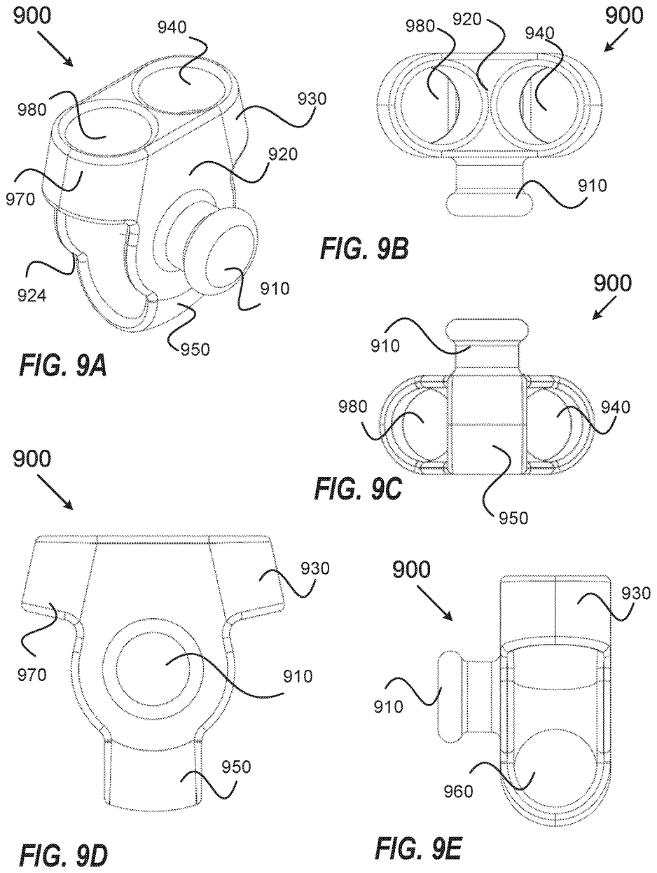

FIGS. 9A-E illustrate perspective, top, bottom, side and front views of the example thimbles 900 (the views are based on how the thimble 900 would be configured in the hoist ring 600 of FIG. 6). The thimbles 900 includes a main body 920 having a flanged arm 910 extending from a center thereof. The flanged arm 910 has an outer portion that is wider than an inner portion. The outer portion is designed to be secured within the enclosed channels 740 when the base 800 and the upper portion 700 are secured together. The arm 910 of the thimble 900 can be placed within the channel 740 such that the flanged portion is located within the upper portion 700. The base 800 is then secured thereto which secures the arm 910 therewithin and the thimble 900 to the body.

An exterior of the main body 920 has sidewalls 924 extending therefrom to create a groove/open channel 922 (not really visible and not identified) therearound for receiving the bail 100 therein. Several flanges (3 illustrated) 930, 950, 970 are located along an exterior to enclose the groove and create closed channels 940, 960, 980 for securing the bail 100 to the thimble 900. Flanges located in proximity to the top of the thimble 900 along each side thereof (e.g., 930, 970) are desirable to secure the bail 100 to the thimble 900 while other flanges (e.g., 950) may provide additional support but may not be required and it may be difficult to route the bail 100 through the associated channel (e.g., 960). The number and location of flanges is not limited to the illustrated embodiment. The groove 922 and the closed channels (e.g., 940, 980) ensures that the bail 100 remains connected to the thimbles 900 when the hoist ring 600 is under a load, whether the load is in line or an angle.

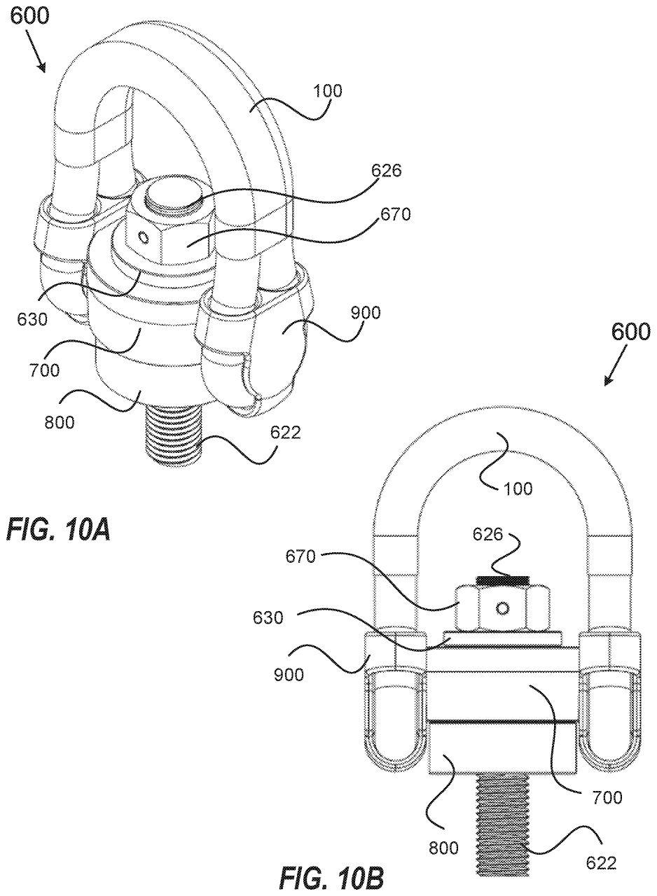

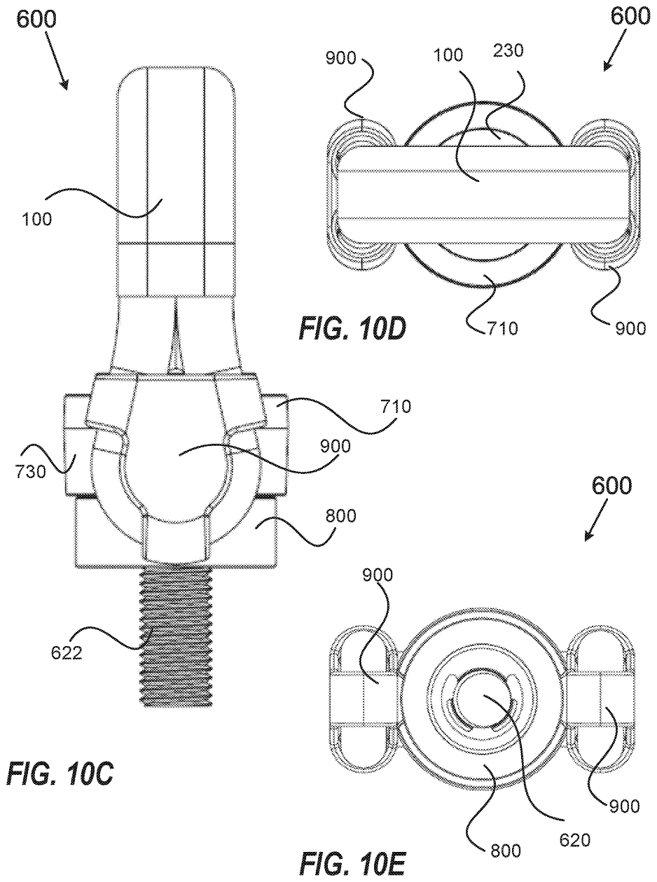

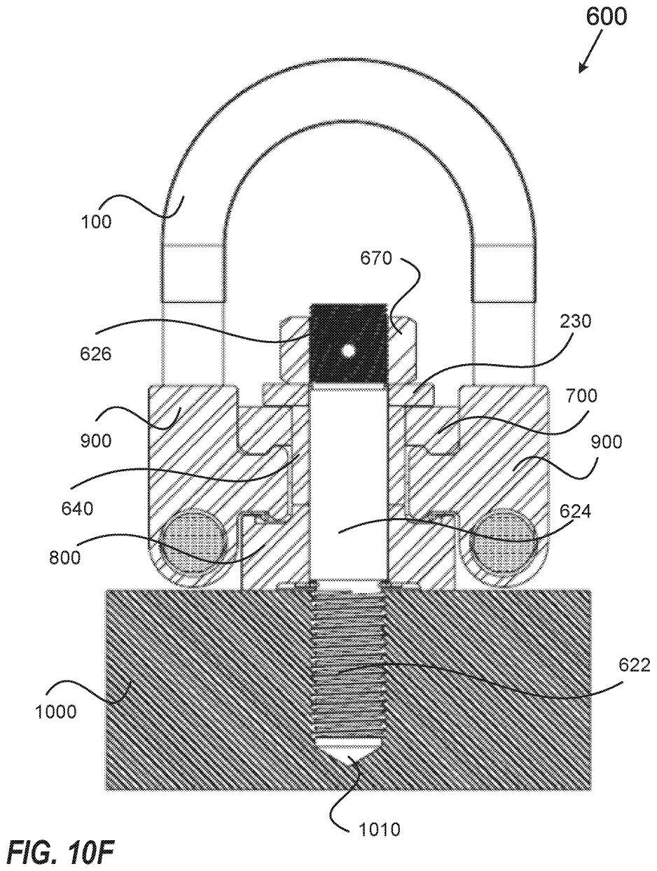

FIGS. 10A-E illustrate perspective, front, side, top and bottom views of the example light weight load bearing hoist ring 600. FIG. 10F illustrates a front cross-sectional view of the example hoist ring 600 being secured to a load 1000. The threaded portion 622 is screwed into a threaded hole 1010 in the load 1000.

The bail 100 of the hoist ring 600 may pivot 180 degrees with respect to the upper portion 700. The upper portion 700 and the bail 100 may swivel 360 degrees around the connection point between the load and the load connection device (the base 800 and the rod 520).

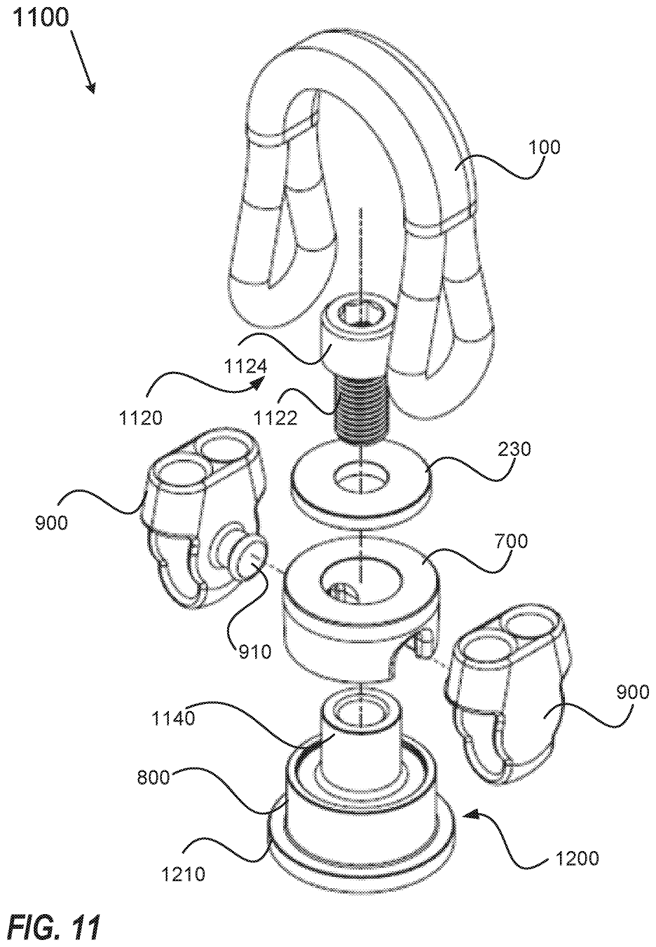

FIG. 11 illustrates an exploded view of an example light weight load bearing hoist ring 1100. The hoist ring 1100 is similar to the hoist ring 600 except it is designed to be welded to a load as opposed to be screwed thereinto. Items in the hoist ring 1100 included in the hoist rings 200, 500, 600 will not be discussed in detail here as they were previously discussed. The load connection device includes a body (consisting of the upper portion 700 and a weldable base 1200), a bolt 1120 (having a threaded portion 1122 and a head 1124), and the washer 230. The weldable base 1200 includes a weldable plate 1210, having the base 800 and a threaded bushing 1140 secured thereto. The weldable base 1200 is welded to a desirable location on a load to function as a lifting point. The flanged arms 910 enter the channels 740 and are then secured in place when the upper portion 700 is rotatably secured to the base 800 of the weldable base 1200. The washer 230 is located on top of the upper portion 700 and the bolt 1120 is threaded in the bushing 1140 to secure the upper portion 700 to the weldable base 1200.

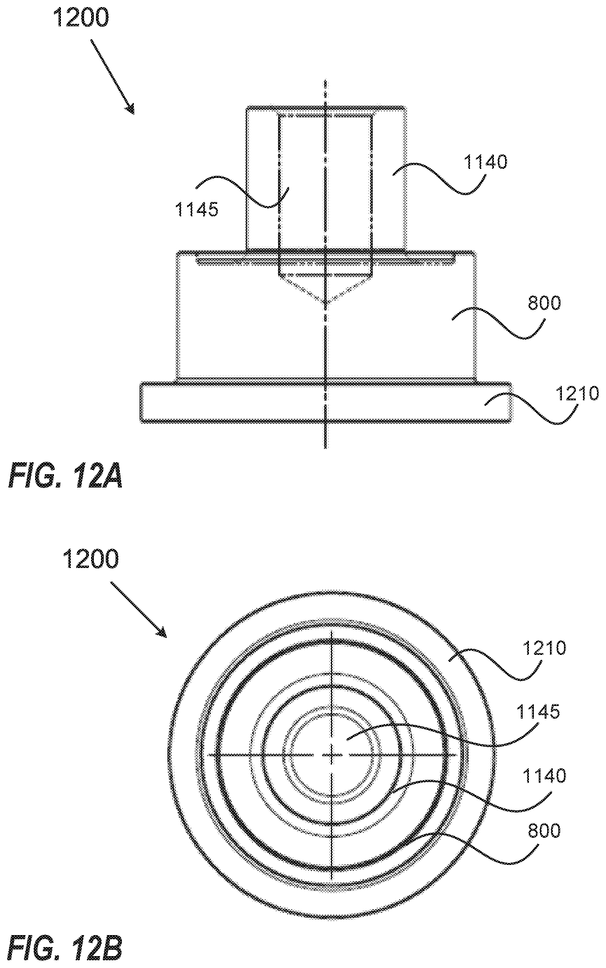

FIGS. 12A-B illustrate front and top views of an example weldable base 1200 of an example body of an example load connection device. The weldable base 1200 has a circular shape and includes the weldable plate 1210, the base 800 mounted to the weldable plate 1210 and the threaded bushing 1140 mounted to the base 800. A threaded hole 1145 extends through the threaded bushing 1140 and into the base 800 to receive the threaded portion 1122 of the bolt 1120. An upper surface of the base 800 includes an inner and outer raised portion 820, 830 for securing the bushing 1140 and the upper portion 700 receptively. When the base 800 and the upper portion 700 are secured together the bushing 1140 is located therebetween and the channels 740 are enclosed.

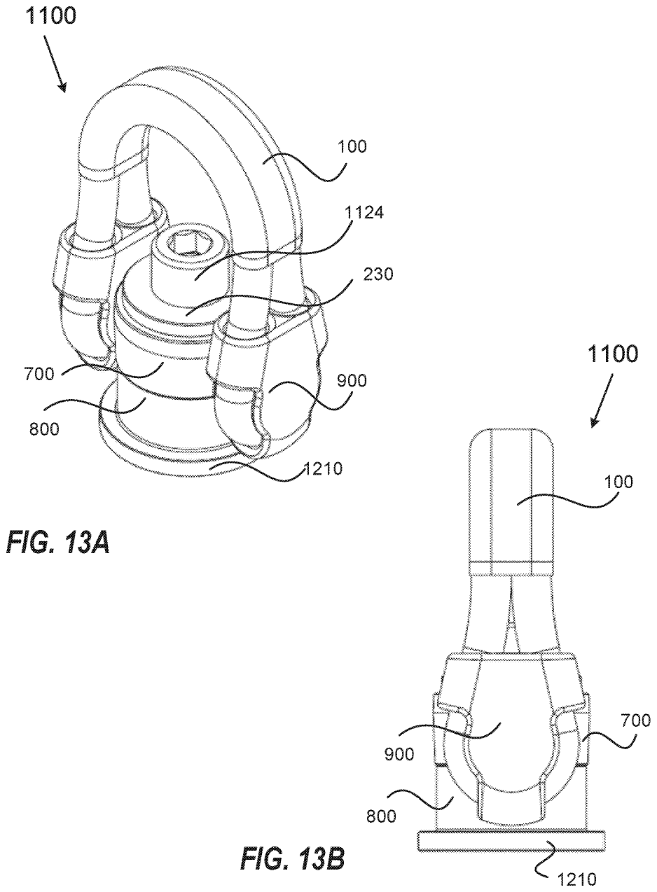

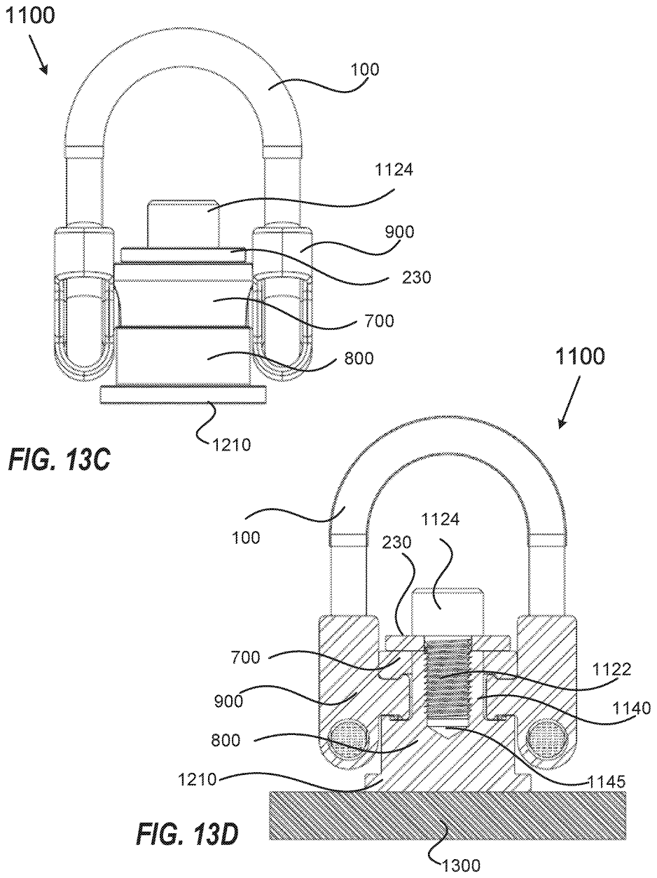

FIGS. 13A-C illustrate perspective, side and front views of the example light weight load bearing hoist ring 1100. FIG. 13D illustrates a front cross-sectional view of the example hoist ring 1100 being secured to a load 1300. The weldable plate 1210 is welded to the load 1000 and the upper portion 700 is rotatably secured to the base 800 with the bolt 1120.

The bail 100 of the hoist ring 1100 may pivot 180 degrees with respect to the upper portion 700. The upper portion 700 and the bail 100 may swivel 360 degrees around the connection point between the load and the load connection device (the weldable base 1200).

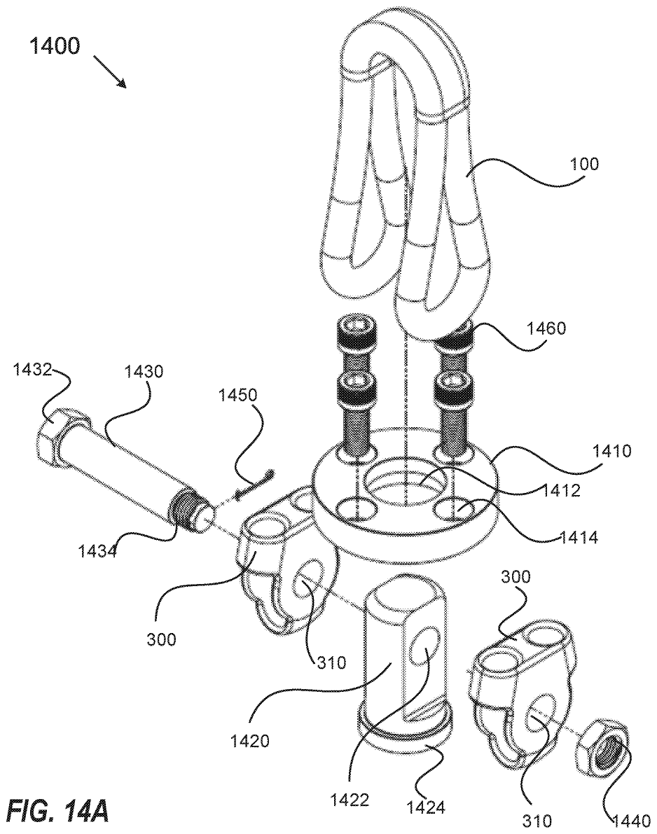

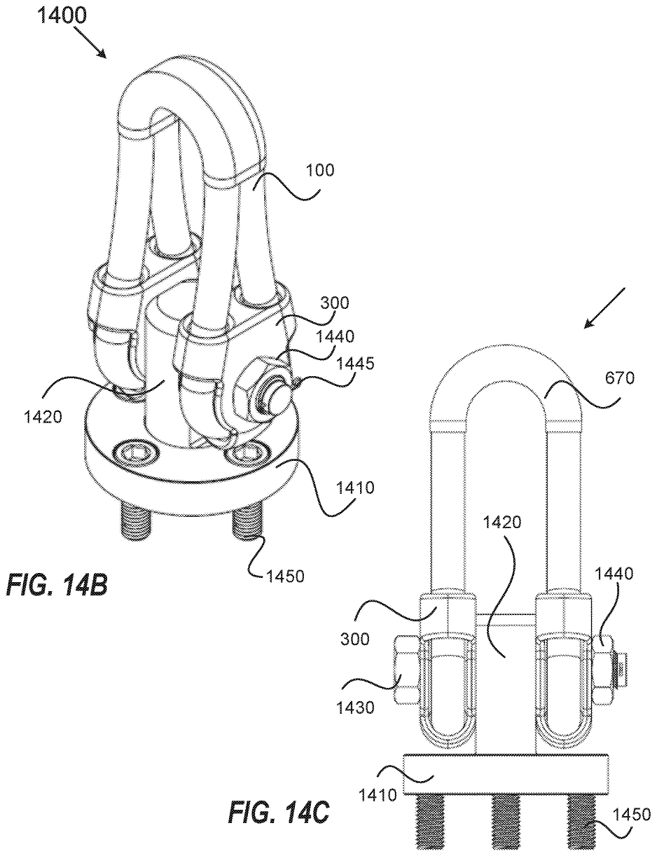

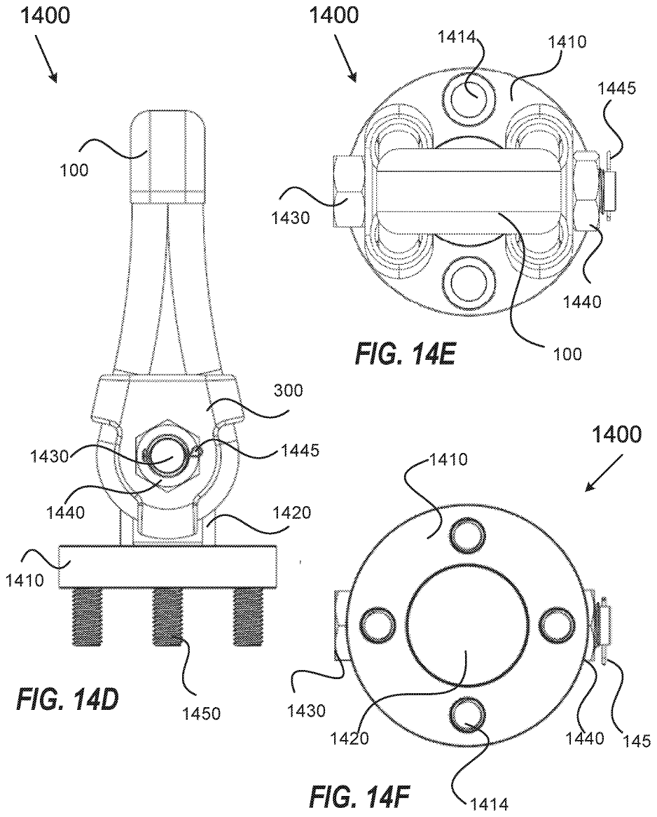

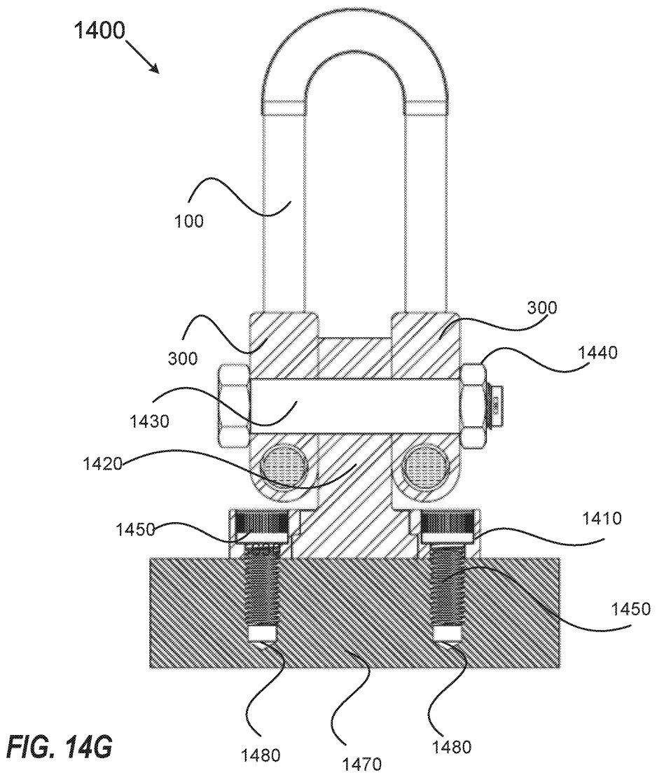

FIGS. 14A-14F illustrate exploded, perspective, front, side, top and bottom views of an example light weight fiber rope hoist ring 1400. Items discussed with respect to any of the previous hoist rings will not be discussed in detail here as they were previously discussed. The load connection device includes a mounting plate 1410, a body 1420 and a connection pin 1430. The mounting plate 1410 includes a center hole 1412 for receiving the body 1420. The body 1420 includes a flange 1422 along a lower edge to enable the mounting plate 1410 to sit thereon (prevent the body 1420 from passing through the hole 1412). The mounting plate 1410 also includes a plurality of mounting holes 1414 (4 illustrated) for receiving bolts 1460 to secure to a load. The body 1420 includes flat sides for abutting the thimbles 300 and has a hole 1424 passing therethrough in alignment with the holes 310. The body 1420 is secured to the thimbles 300 by passing the connection pin 1430 through the aligned holes 310, 1420, 310 in a first thimble 300, the body 1420 and a second thimble 300. The connection pin 1430 includes a head 1432 to prevent the connection pin 1420 from traversing completely through the thimble 300 and a threaded end 1424 to secure a nut 1440 thereon to secure the connection pin 1420 in place. The connection pin 1420 may also include a hole (not identified) external to the threaded end 1424 to receive a pin 1445 to ensure the nut 1440 does unthread from the connection pin 1430.

The plate 1410 is configured to hang below the thimbles 300 so that the thimbles 300 do not interfere with the plate 1410. The plate 1410 may be located on the body 1420 and then the plate 1410 may be secured to a load by placing bolts 1460 in aligned holes in the load. The body 1420 may then be secured to the thimbles 300 that are located in the sling bail 100.

FIG. 14G illustrates a front cross-sectional view of the example hoist ring 1400 being secured to a load 1470. The plate 1410 located on the body 1420 is secured to the load 1470 by placing bolts 1460 through the holes 1414 into aligned holes 1480 in the load 1470.

The bail 100 of the hoist ring 1400 may pivot 180 degrees with respect to the body 1420. The body 1420 and the bail 100 may swivel 360 degrees around the connection point between the load and the load connection device (the plate 1410).

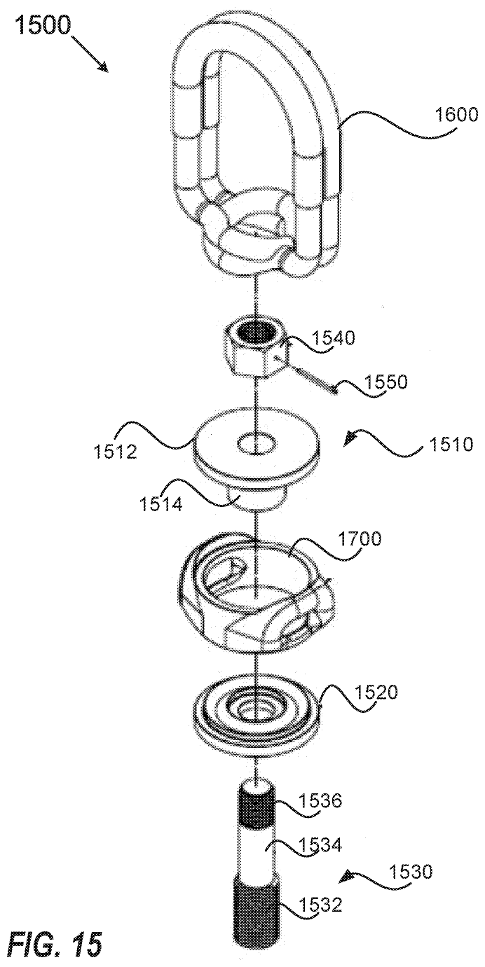

FIG. 15 illustrates an exploded view of an example light weight fiber rope hoist ring 1500 that does not include thimbles. The hoist ring 1500 includes a round sling bail 1600 and a load connection device. The load connection device includes a body 1700, a base 1520, a bushing 1510 (flange 1512, sleeve 1514) and a rod 1530 (first threaded portion 1532, non-threaded portion 1534, second threaded portion 1536). The bail 1600 is secured directly to the load connection device and does not require thimbles within each open end of the bail 1600. Rather, each open end of the bail 1600 wraps around the rod 1530 that passes through the load connection device to secure it thereto. The bushing 1510 sits on top of the body 1700. The rod 1530 passes through the bushing 1510, the body 1700 and the base 1520 and is secured above the bushing 1510 with a threaded nut 1540 being threaded onto the second threaded portion 1536. The nut 1540 may be held in place additionally with a pin 1550 passing through aligned holes (not identified) in the nut 1550 and the second threaded portion 1536.

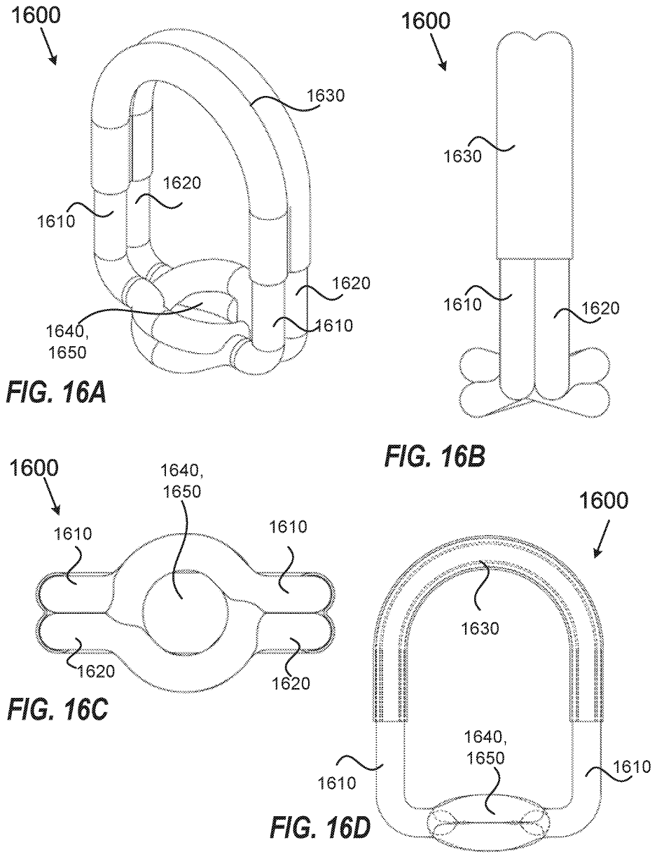

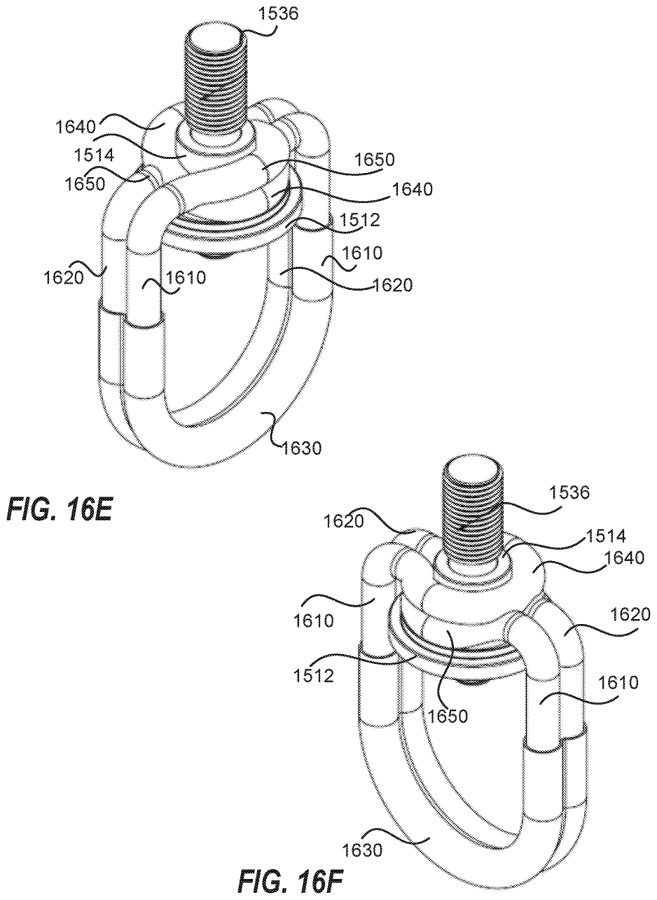

FIGS. 16A-D illustrate perspective, side, top and front cross-sectional views of a configuration of the example bail 1600. Like the bail 100 previously illustrated and discussed, the bail 1600 includes a first side 1610 and a second side 1620 that are secured together along a center portion 1630 (may be secured within an additional sheathing). Each end of the bail 1600 forms a loop 1640, 1650. The loops 1640, 1650 are turned inward toward each other so as to be in alignment with each other (since the loops are overlapping you cannot distinguish the loops and they are simply labeled 1640, 1650). The loops 1640, 1650 may be twisted such that a first loop (e.g., 1640) is on top on one side and a second loop (e.g., 1650) is on top on the other side. Alternatively, the loops 1640, 1650 may simply overlap each other where a first loop (e.g., 1640) is on top and a second loop (e.g., 1650) is on bottom. According to one embodiment, the first side 1610 and second side 1620 of each loop 1640, 1650 may cross before the loops 1640, 1650 are aligned and overlapping. The loops 1640, 1650 may enter opposite sides of the body 1700 and be wrapped around the rod 1530 and the bushing sleeve 1514 located therewithin.

FIGS. 16E-F illustrate perspective views of the loops 1640, 1650 wrapped around the rod 1530 and the bushing sleeve 1514. The body 1700 is not illustrated for ease of illustration. FIG. 16E illustrates the loops 1640, 1650 twisted while FIG. 16F illustrates the loops 1640, 1650 one on top of the other.

As illustrated, the bushing 1510 is shown on top and the sling 1600 is located therebelow. This may be the manner that the hoist 1500 is configured to enable connection of the bail 1600 to the load connection device. The bushing 1510 may be placed on the housing 1700 where the flange 1512 rests on an upper surface and the sleeve 1514 is located in an interior thereof. The housing 1700 may then be flipped upside down so that the sleeve 1514 is facing upward making placing the lops 1640, 1650 thereover easier. The loops 1640, 1650 may enter opposite sides of the housing 1700 and be placed over the sleeve 1514. The rod 1530 may then pass through the sleeve 1514 and be secured thereto with the nut 1540. The base 1520 may then be secured to the housing 1700 and the load connection device may be rotated to its appropriate configuration.

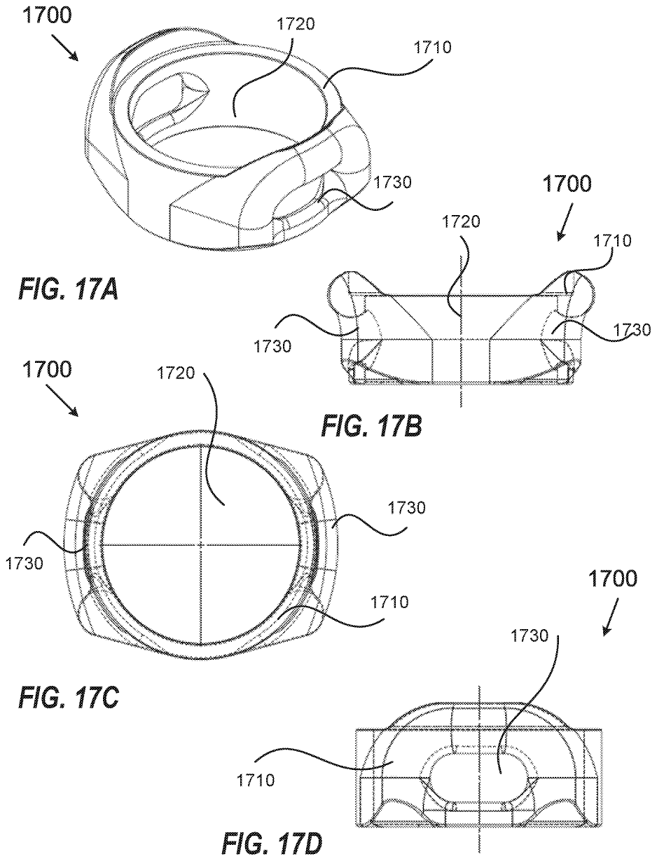

FIGS. 17A-D illustrate perspective, front, top and side views of the example housing 1700. The housing 1700 includes a substantially circular body 1710 providing a perimeter thereof and providing an opening 1720 therethrough. Along each side of the body 1710 is an opening 1730 for receiving the loops 1640, 1650. The body 1710 may be a little thicker at this point for additional support. The body 1710 may also extend upward at this point to provide a seat for the flange 1512 to sit within.

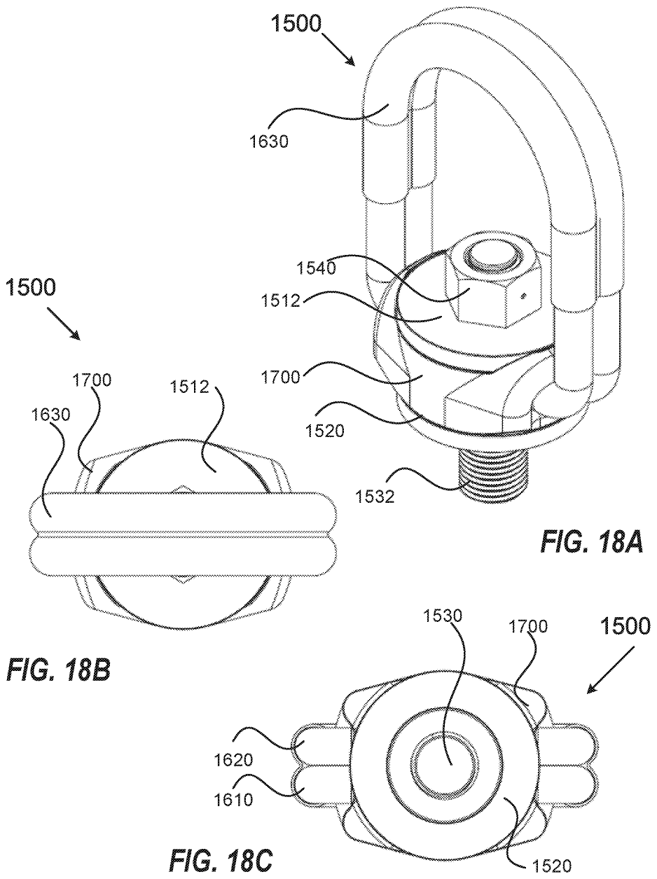

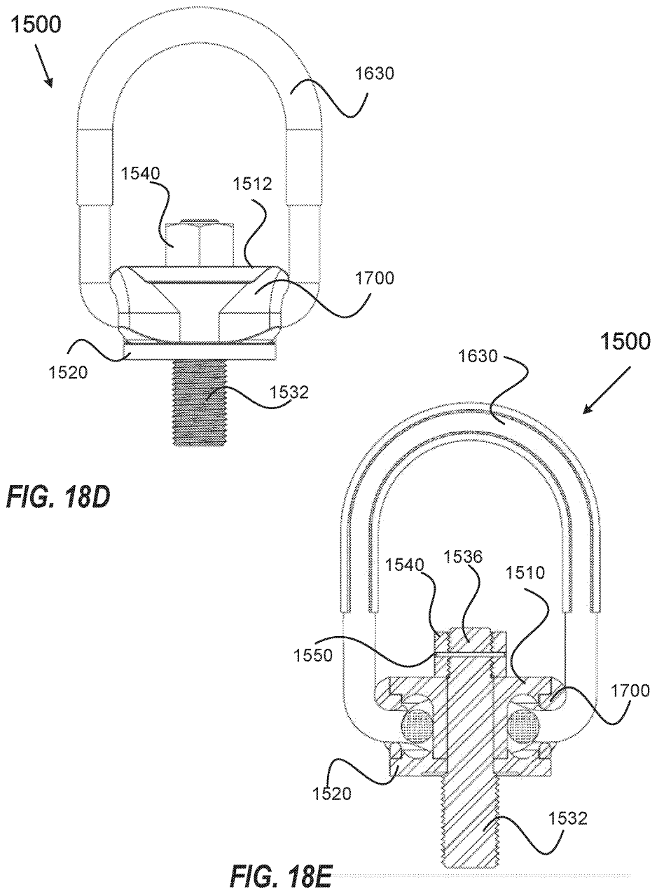

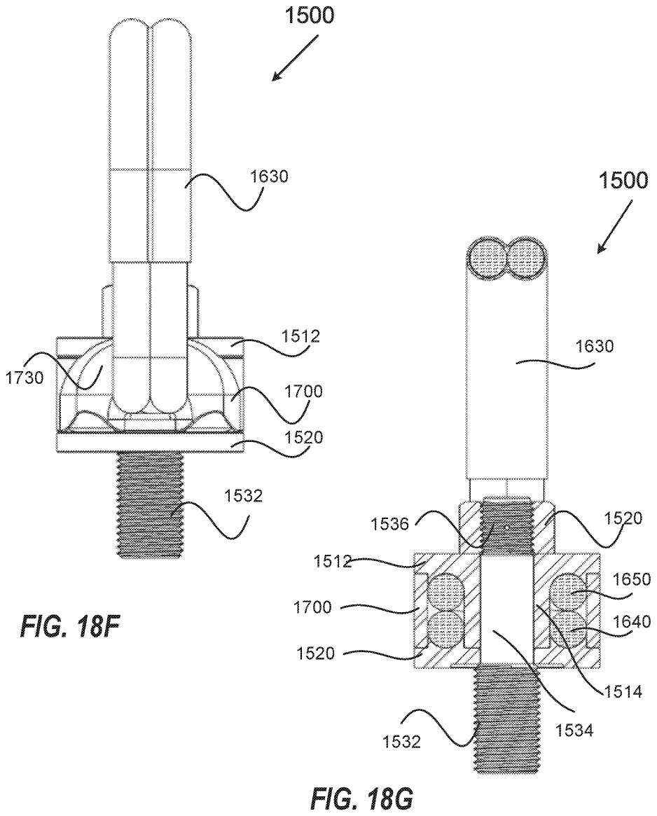

FIGS. 18A-G illustrate perspective, top, bottom, front, front cross-sectional, side and side cross-sectional views of the example hoist 1500. The loops 1640, 1650 secured around the rod 1530 within the housing 1700 ensures that the bail 1600 remains connected to the load connection device when the hoist ring 600 is under a load, whether the load is in line or an angle.

The bail 1600 of the hoist ring 1500 may pivot 180 degrees with respect to the body 1700. The body 1700 and the bail 1600 may swivel 360 degrees around the connection point between the load and the load connection device (the rod 1530).

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A light weight load bearing hoist ring comprising
a bail made of a plurality of loops of fiber rope secured within a sheathing, wherein a first side and a second side of the bail is secured together along a center portion, wherein the first side and the second side are not secured together at a first end to create a first leg having a first loop and at a second end to create a second leg having a second loop; and
a load connection device located between and connected to the first leg and the second leg of the bail and configured to secure to a load to be lifted utilizing the hoist ring, wherein the bail is capable of pivoting with respect to the load connection device and the bail and the load connection device can swivel with respect to the load without disconnecting from the load.

2. The hoist ring of claim 1, wherein the fiber rope includes fibers selected from at least one of polypropylene, nylon, polyesters, polyethylene, Aramids and acrylics.

3. The hoist ring of claim 1, wherein the fiber rope includes mixtures of several fibers or co-polymer fibers.

4. The hoist ring of claim 1, wherein the fiber rope includes fibers selected from at least one of straight, braided and twisted.

5. The hoist ring of claim 1, wherein the load connection device is screwed into the load.

6. The hoist ring of claim 1, wherein the load connection device is welded to the load.

7. The hoist ring of claim 1, further comprising thimbles secured within the first and the second loop of the bail, wherein the load connection device is connected to the thimbles.

8. The hoist ring of 7, wherein the thimbles include a channel around a perimeter thereof that the bail traverses within and one or more flanges extending therefrom to create one or more enclosed channels to secure the bail to the thimble.

9. The hoist ring of 8, wherein the bail remains connected to the thimbles when the hoist ring is under an in line load or an angled load.

10. The hoist ring of claim 1, wherein the load connection device includes a body, a bolt and a bushing, wherein the body is connected to the bail, the bolt is secured within the body and is to connect to the load, and the bushing enables the body to swivel without disengaging the bolt from the load.

11. The hoist ring of claim 10, wherein the body is connected to thimbles secured within the first and the second loop of the bail.

12. The hoist ring of claim 11, wherein the body is secured to the thimbles with connection pins.

13. The hoist ring of claim 11, wherein the thimbles include flanged arms extending therefrom that are used to secure the thimbles to the body.

14. The hoist ring of claim 1, wherein the load connection device includes a body and a plate having a plurality of holes therein, wherein the body is connected to the bail, the plate is secured on the body and the holes are to receive bolts to secure the plate to the load.

15. The hoist ring of claim 14, wherein the body can swivel around the plate when the plate is secured to the load without disengaging the bolts from the load.

16. The hoist ring of claim 14, wherein the body is connected to thimbles secured within the first and the second loop of the bail.

17. The hoist ring of claim 16, wherein the plate is located on the body below the thimbles so the thimbles do not interfere with securing the plate to the load.

18. The hoist ring of claim 1, wherein
the load connection device includes a body, a bolt and a bushing;
the bushing is located within the body;
the first loop enters the body from a first side and is placed over the bushing;
the second loop enters the body from a second side and is placed over the bushing; and
the bolt is secured within the body, passes through the bushing and extends from the body to connect to the load.

19. The hoist ring of claim 18, wherein the load connection device further includes a base located between the body and the load.

20. The hoist ring of claim 1, wherein the bail has a substantially round cross-sectional profile.
